(19) United States
(12) Patent Application Publication
(10) Pub. No.: US 2008/0225642 A1
(43) Pub. Date: Sep. 18, 2008

(54) Interpolation of Irregular Data

(76) Inventors: Ian Moore, Cambridge (GB); Ralf Ferber, West Sussex (GB)

Correspondence Address: WesternGeco L.L.C.;Jeffrey E. Griffin, 10001 Richmond Avenue, HOUSTON, TX, 77042-4299, US

(21) Appl. No.: 12/043,321

(22) Filed: Mar. 6, 2008

Related U.S. Application Data
(60) Provisional application No. 60/895,347, filed on Mar. 16, 2007.

(51) Int. Cl. G01V 1/28

(52) U.S. Cl. 367/73

(57) ABSTRACT

Implementations described herein provide methods and devices for interpolating or estimating data from previously acquired data. Furthermore, implementations described herein calculate optimum interpolation operators by maximizing the spatial bandwidth of interpolation operators within a specified acceptable mean square error. According to one implementation, spatial bandwidth may be maximized by selecting a local grid within a global grid having nodes corresponding to desired interpolation locations. According to another implementation, spatial bandwidth may be maximized by specifying maximum wave numbers when calculating interpolation operators.

### CROSS-REFERENCE TO RELATED APPLICATIONS

This application claims benefit of United States provisional patent application Ser. No. 60/895,347, filed Mar. 16, 2007, which is incorporated herein by reference

### BACKGROUND

1. Field of the Invention

Implementations of various techniques described herein generally relate to data processing. More specifically, various techniques described herein generally relate to seismic data processing.

2. Description of the Related Art

The following descriptions and examples do not constitute an admission as prior art by virtue of their inclusion within this section.

In a typical seismic survey, a plurality of seismic sources, such as explosives, vibrators, airguns or the like, may be sequentially activated at or near the surface of the earth to generate energy which may propagate into and through the earth. The seismic waves may be reflected back by geological formations within the earth. The resultant seismic wave field may be sampled by a plurality of seismic sensors, such as geophones, hydrophones and the like. Each sensor may be configured to acquire seismic data at the sensor's location, normally in the form of a seismogram representing the value of some characteristic of the seismic wave field against time. The acquired seismograms or seismic data may be transmitted wirelessly or over electrical or optical cables to a recorder system. The recorder system may then store, analyze, and/or transmit the seismograms. This data may be used to detect the possible presence of hydrocarbons, changes in the subsurface and the like.

In some circumstances, sampled data (e.g., the seismic data described above) may be acquired at irregular locations. That is, data may be acquired from locations which were not planned to be sampled. For example, seismic data may be planned to be sampled in a first location. However, an obstacle (e.g., a building) may be located on top of the first location. Consequently, a sensor or receiver may not be placed at the planned first location. Therefore, the sensor may have to be placed in a second location which is close to the first location, but is not the same as the planned location. This second location may be referred to as an irregular location. Many receivers may acquire seismic data at irregular locations resulting in irregularly spaced data.

After acquiring sampled data, the data may be processed using specific signal-processing algorithms. For example, Fourier transforms may be applied to the data. The signal-processing algorithms (e.g., Fourier transforms) may require the data to be located at regularly spaced locations. For example, the algorithms may require the data to be located at the nodes of a regularly spaced grid (e.g., a Cartesian grid). If the data is not located at regularly spaced locations, the results of the signal-processing algorithms may be inaccurate or distorted. Consequently, using irregularly sampled data may result in inaccurate or distorted results.

One solution to the problem of having data at irregularly spaced locations while the data is needed at regularly spaced locations is to use the data at the irregularly spaced locations to estimate the data at regularly spaced locations. Obtaining data at regular locations from data which was measured at irregular locations is commonly referred to as re-sampling or interpolation. The process of interpolating data or re-sampling data onto a regular grid from data sampled at irregular locations is called regularization or gridding. Regularization of seismic data is often a very important pre-processing step for several data processing algorithms, including 3-dimensional SRME, migration and 4-dimensional survey matching.

Although the aforementioned interpolation techniques allowed for estimation of data from irregularly spaced samples, the accuracy of interpolated data from the aforementioned techniques may still be improved and the interpolated data also suffers from the effects of noise.

### SUMMARY

Described herein are implementations of various techniques for interpolating irregularly sampled data.

In one implementation, a method for interpolating seismic data is provided. The method may include: receiving seismic data acquired at irregularly spaced sensor locations; defining a global grid having nodes corresponding to locations where seismic data values are desired; selecting an output location corresponding to a node on the global grid; setting a maximum bandwidth for an interpolation operator; and computing the interpolation operator for the selected output location based on the maximum bandwidth.

In another implementation, another method for interpolating seismic data is provided. The method may include: receiving seismic data acquired at irregularly spaced sensor locations; defining a global grid having nodes corresponding to locations where seismic data values are desired; selecting actual sensor locations within a vicinity of a desired interpolation location residing on the global grid; selecting an acceptable mean square error for an interpolation operator; selecting a local grid for the interpolation location; and forming a matrix of interpolation coefficients for the local grid.

In yet another implementation, another method for interpolating seismic data is provided. The method may include: receiving seismic data acquired at actual sensor locations; defining a global grid having nodes corresponding to locations where data values are desired; selecting actual sensor locations within a vicinity of an interpolation location residing on the global grid; selecting an acceptable mean square error for an interpolation operator; selecting a maximum bandwidth for the interpolation operator; forming a matrix of interpolation coefficients based on the separable sinc function of the differences of actual sampling locations; forming a vector based on separable sinc functions of the difference of selected actual sampling locations and the selected interpolation location; and forming an interpolation operator vector by application of the inverse of the matrix of interpolation coefficients to the vector.

In still another implementation, a computer readable medium containing a program is provided. When executed, the program performs operations that include: perform operations comprising: receiving seismic data acquired at irregularly spaced sensor locations; defining a global grid having nodes corresponding to locations where seismic data values are desired; selecting an output location corresponding to a node on the global grid; setting a maximum bandwidth for an interpolation operator; computing the interpolation operator for the selected output location based on the maximum bandwidth; computing a mean square error for the interpolation operator; determining if the mean square error for the interpolation operator is acceptable; and if the mean square error is acceptable, calculating an interpolated seismic data value for the selected output location using the interpolation operator and the acquired seismic data.

In still yet another implementation a computer system is provided. The computer system may include: a processor; and memory comprising program instructions executable by the processor to: receive seismic data acquired at irregularly spaced sensor locations; define a global grid having nodes corresponding to locations where seismic data values are desired; select an output location corresponding to a node on the global grid; set a maximum bandwidth for an interpolation operator; compute the interpolation operator for the selected output location based on the maximum bandwidth; compute a mean square error for the interpolation operator; and determine if the mean square error for the interpolation operator is acceptable.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIGS. 1, 4 and 6 illustrate exemplary spatial sampling regimes.

FIG. 2 is a flowchart illustrating an exemplary method of spatial interpolation using bandwidth optimized operators, according to one or more implementations of various techniques described herein.

FIG. 3 is a flowchart illustrating an exemplary method of block uniform spatial interpolation with local grid optimization, according to one or more implementations of various techniques described herein.

FIG. 5 is a flowchart illustrating an exemplary method of block minimum mean square error interpolation with bandwidth optimization, according to one or more implementations of various techniques described herein.

FIG. 7 illustrates exemplary weighting of interpolation operators and corresponding sampled data, according to one or more implementations of various techniques described herein.

FIGS. 8 and 9 illustrate exemplary mean square error spectra, according to implementations described herein.

FIG. 10 is a schematic diagram of an exemplary computer network in accordance with implementations of various techniques described herein.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

Hendriks and Duijndam proposed the use of least-squares estimation of the Fourier components for data construction in “Reconstruction of 3-D Seismic Signals Irregularly Sampled Along Two Spatial Coordinates,” Geophysics 56, pp. 253-263. Their proposal consisted of a transformation of the actual data into the wave number domain, and correcting there for distortions due to the irregular sampling. The reconstruction of the data in the space domain is then achieved by an inverse Fourier transform onto a Cartesian spatial sampling grid.

Furthermore, Rosenfeld proposed the rBURS (Block Uniform Re-Sampling) enhanced gridding technique used to interpolate data onto a regularly spaced grid from irregularly spaced samples. Rosenfeld's proposal introduced a regularization parameter during the gridding algorithm. (See Rosenfeld, “New Approach to Gridding Using Regularization and Estimation Theory, Magnetic Resonance in Medicine, 48, pp. 193-202, 2002).

Although the aforementioned interpolation techniques allowed for estimation of data from irregularly spaced samples, the accuracy of interpolated data from the aforementioned techniques may still be improved and interpolated data acquired using the aforementioned techniques also suffers from the effects of noise. Consequently, implementations of the present disclosure provide enhanced interpolation techniques.

The following paragraphs generally describe one or more implementations of various techniques directed to compute interpolated data for an interpolation location as a weighted average of actual data in a proximity or vicinity of the interpolation location. Various implementations described herein compute optimum interpolation operators having acceptable mean square errors and having a maximum spatial bandwidth (e.g., over the widest possible wave number band). Multiple implementations for computing optimum interpolation operators for each interpolation location are presented herein.

One aspect of the implementations described herein concerns an enhancement of the Block Uniform Re-Sampling (rBURS) algorithm introduced by Rosenfeld. According to the enhanced BURS implementation described herein, in addition to a global grid with nodes corresponding to interpolation locations, local grids are introduced at each desired interpolation location and are used to calculate optimum interpolation operators. The local grids may have different spacing than the spacing of the global grid.

Another aspect of the implementations described herein concerns interpolation of data using an interpolation operator which is calculated by varying a wave number. The wave number may be varied to calculate an interpolation operator having an acceptable mean square error for each interpolation location.

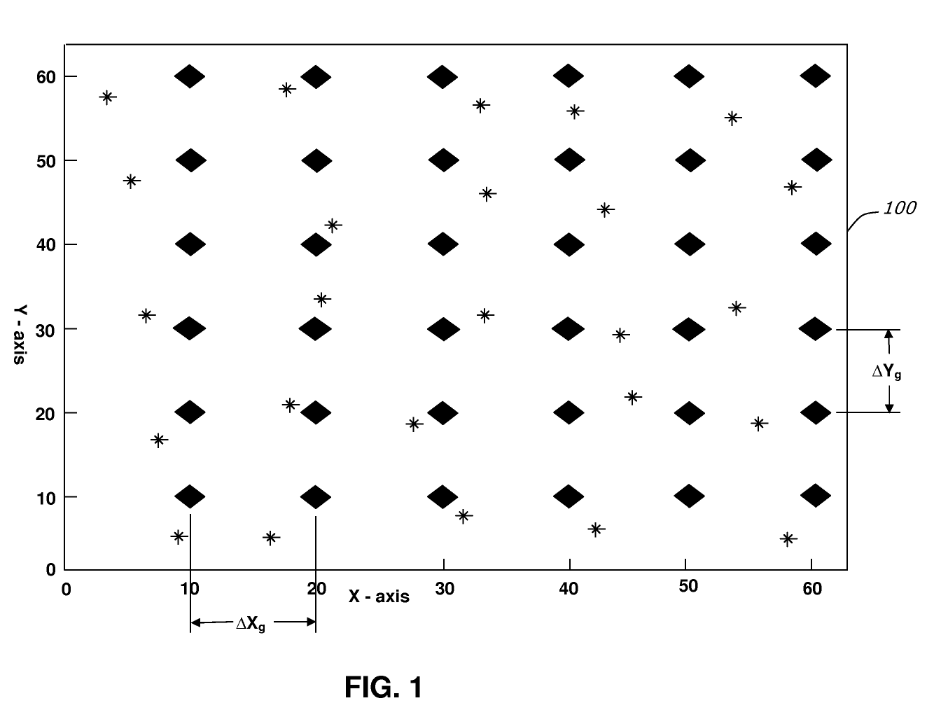

Additionally, some implementations described herein are configured to enhance the minimum mean square design of interpolation operators. Specifically, some implementations incorporate the spatial bandwidth in the interpolation operator design criterion such that the computed interpolation operator has a mean square error not exceeding a user specified threshold over the largest possible spatial bandwidth. One or more implementations of various techniques for computing interpolated data will now be described in more detail with reference to FIGS. 1-10 and in the following paragraphs.

### Spatial Interpolation Using Bandwidth Optimized Local Operators

As described above, data (e.g., seismic data) is often acquired from a plurality of irregularly spaced locations. Furthermore, it may be desirable to estimate or interpolate data (e.g., seismic data) from the data acquired at a plurality of irregularly spaced locations. It may also be desirable to estimate or interpolate data at a plurality of locations which are regularly and evenly spaced, for example at the nodes of a grid.

For example, FIG. 1 illustrates exemplary data acquired within an area 100. The smaller stars within the area 100 illustrate locations where the data was acquired. In contrast, the larger diamonds illustrate locations where data values are desired. These locations where the larger diamonds are located may be known herein as interpolation locations, since various implementations described herein may interpolate or estimate data values at these locations.

As illustrated in FIG. 1, the locations where the data was obtained are irregularly spaced. Consequently, using the data from the irregularly spaced locations where the seismic data was obtained to perform data processing may yield distorted results. Using regularly and evenly spaced seismic data, e.g., the data values at locations illustrated by the larger diamonds, to perform data processing may yield better results (i.e., less distorted results) than using the irregularly spaced data. Therefore, it may be desirable to estimate or interpolate data values at the interpolation locations using the previously acquired and irregularly data.

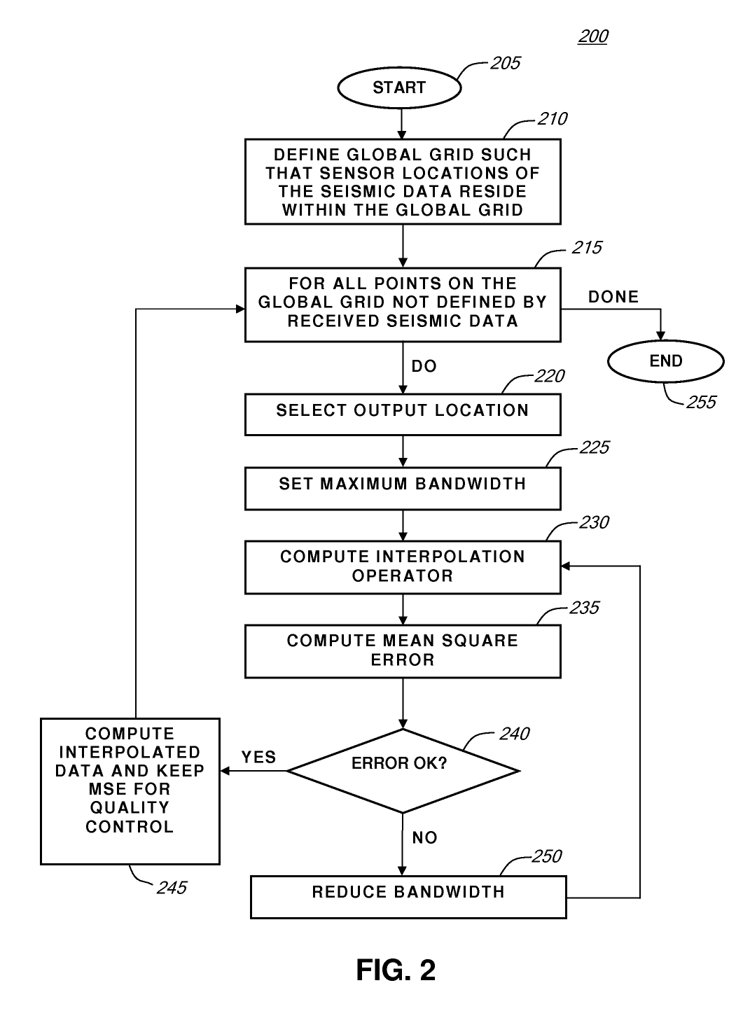

FIG. 2 is a flowchart illustrating a method 200 for estimating or interpolating data values (e.g., seismic data values) at desired locations using data acquired at locations different from the desired locations. Method 200 may estimate the data values at the desired locations through the use of a weighted average of actual data in a neighborhood or vicinity of the desired locations. Method 200 may use bandwidth optimized local interpolation operators to interpolate data at the desired interpolation locations.

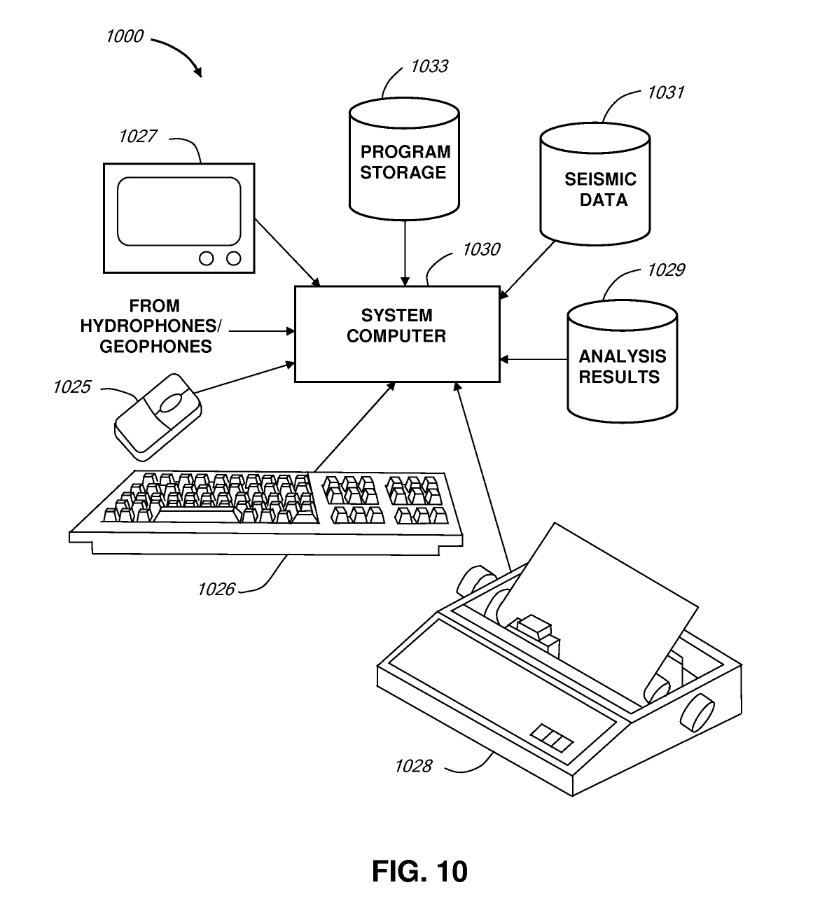

Method 200 may begin at step 205 for example when data (e.g., seismic data) has been acquired at irregularly spaced locations (e.g., as illustrated in FIG. 1). The data may be acquired through any suitable means. For example, seismic data may be acquired via a land based system consisting of land based sensors at various locations on land or a marine based system consisting of sensors towed behind an ocean vessel. After acquiring the data, the data may be processed or manipulated by a computing system or a data processing system. One implementation of a data processing system is described below with respect to FIG. 10.

After receiving the irregularly spaced data, at step 210 the data processing system may define a global grid. The global grid may be defined such that the nodes of the grid are at locations where data values are desired. That is, the nodes of the global grid may correspond to the interpolation locations. The grid may be any type of grid corresponding to the desired interpolation locations, such as, a Cartesian grid, a rectilinear grid, etc. For example, the data processing system may define a global grid similar to the grid formed by the large diamonds illustrated in FIG. 1. Also, the grid may be defined such that all of the irregularly spaced data resides within the global grid. The spacing of the nodes of the global grid may be represented by Δxg corresponding to a spacing along an x-axis, and Δyg corresponding to a spacing along a y-axis. The global grid illustrated in FIG. 1 is two-dimensional. However, implementations described herein may be used to estimate or interpolate data in smaller or larger dimensions (e.g., 1D, 3D, etc.) and thus, the global grid may have smaller or larger dimensions.

Next, at step 215 of method 200 the data processing system may enter a processing loop including steps 220-250. The processing loop may execute for each location or node within the global grid. That is, the processing loop may execute for each location on the grid for which a data value needs to be interpolated.

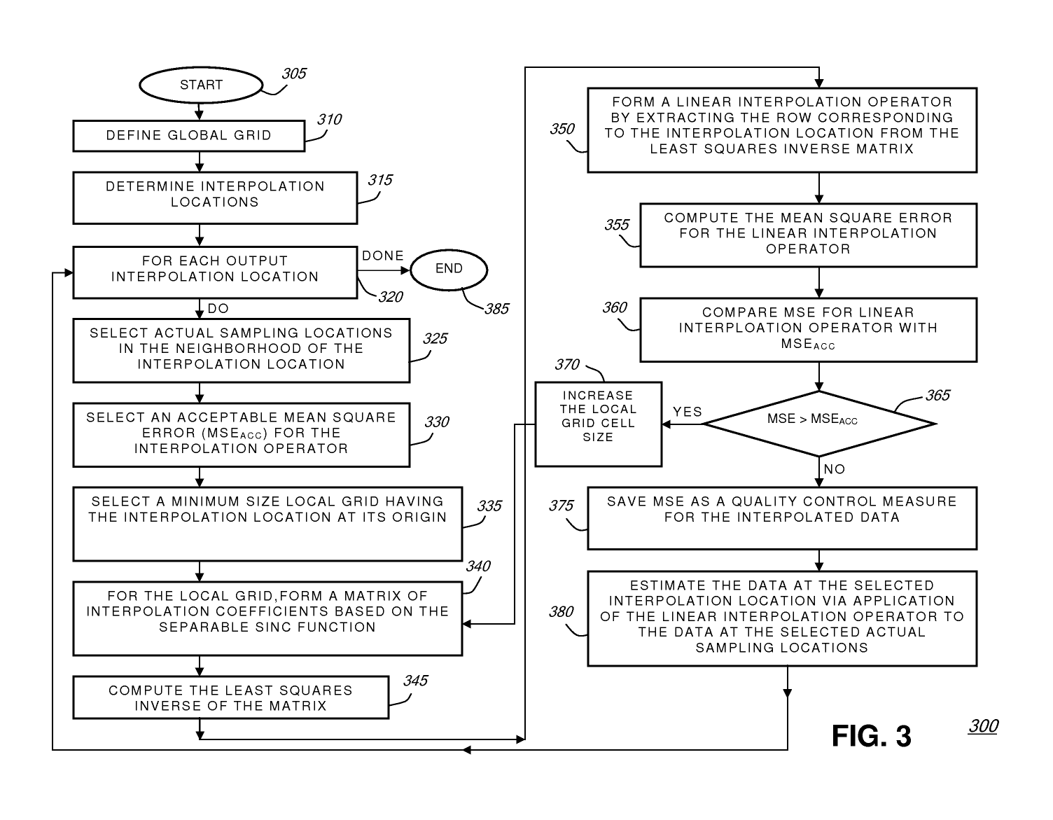

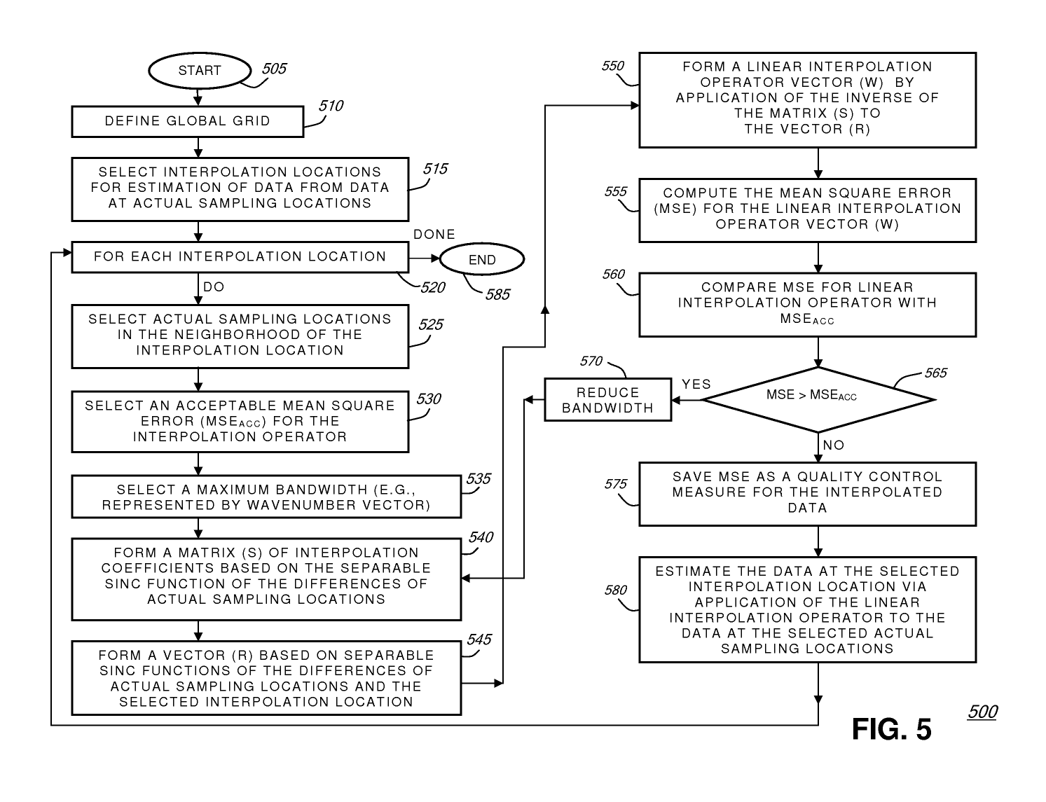

During the first step in the processing loop, step 220, the data processing system may select an output location or node on the grid for which a data value is to be estimated/interpolated. In one implementation, the data processing system may select the next interpolation location on the global grid. Next, at step 225 the data processing system (or a user of the data processing system) may set or select a maximum bandwidth for an interpolation operator. As described further below with respect to FIG. 3 and FIG. 5, selecting a maximum bandwidth for the interpolation operator may be accomplished by selecting a minimum size for a local grid or by selecting a maximum wave number. By selecting a maximum bandwidth, various implementations described herein incorporate bandwidth into the design of the interpolation operator which enables the calculation of an optimum interpolation operator.

After setting the maximum bandwidth, at step 230 the data processing system may use the selected maximum bandwidth to calculate an interpolation operator for the output location (i.e., the output location selected in step 220). The interpolation operator may be a weighting value or a number of weighting values which may be used to determine an interpolated value for the interpolation location.

After calculating an interpolation operator, at step 235 a mean square error may be calculated for the interpolation operator. Calculation of a mean square error for the interpolation operator is described further below. Next, at step 240 a determination may be made as to whether or not the mean square error for the interpolation operator is acceptable. An acceptable mean square error for the interpolation operator may be one that is, for example, less than or equal to a pre-defined threshold for the mean square error. Pre-defining a threshold for the mean square error may allow a calculation of an optimal interpolation operator with a maximum spatial bandwidth.

If at step 240 a determination is made that the mean square error for the interpolation operator is not acceptable, the data processing system may proceed to step 245 where the bandwidth may be reduced. After reducing the bandwidth in step 245, the data processing system may return to steps 230, 235 and 240 to compute a new or a second interpolation operator based on the reduced bandwidth, compute a second mean square error for the second interpolation operator, and determine if the second mean square error is acceptable. The data processing system may continue to reduce bandwidth and calculate an interpolation operator based on the reduced bandwidth until an interpolation operator is computed with a mean square error less than the acceptable mean square error. Consequently, an optimal interpolation operator may be calculated.

If at step 240 a determination is made that the mean square error is acceptable, the data processing system may proceed to step 245 where the interpolation operator and the acquired data may be used to estimate/interpolate a data value for the output location selected in step 220. The interpolation operator (which may contain a plurality of weighting values) may be multiplied with the previously acquired data. This product of the weighting values and the actual data values may then be summed to determine an estimated or interpolated data value at the desired interpolation location.

Furthermore, in step 245 the mean square error calculated in step 235 may be saved for quality control purposes. For example, the mean square error may be saved and used for comparison during a later determination of an acceptable mean square error in step 240. Likewise, the mean square error may be saved/displayed and used for comparison during a later execution of step 240. Likewise, a maximum squared error or similar error measure may be computed and saved/displayed for quality control purposes.

The data processing system may then return to step 215 where the data processing system may continue to step 220 if another data value needs to be interpolated at another point on the global grid. Otherwise, the data processing system may proceed to step 255 where method 200 may end.

According to implementations described herein, the data processing system may store the interpolated data for later use, may present the interpolated data visually to a user (e.g., via a monitor, printout, etc), or the data processing system may use the interpolated data for further data processing.

In this manner, method 200 incorporates spatial bandwidth (e.g., user specified spatial bandwidth) in the interpolation operator design criterion, such that the computed interpolated operator has a mean square error not exceeding a user specified threshold (e.g., acceptable mean square error) over the largest possible spatial bandwidth. Consequently, various implementations described herein may increase the accuracy of interpolated data by calculating an optimal interpolation operator having a maximum bandwidth and with a mean square error less than a user specified threshold.

### Block Uniform Spatial Interpolation with Local Grid Optimization

As described above with regards to method 200, implementations described herein may incorporate spatial bandwidth into the design of an optimal interpolation operator. In one implementation, spatial bandwidth may be incorporated into the design of an optimal interpolation operator via an improvement to the rBURS (Block Uniform Re-Sampling) algorithm. The improvement to the rBURS algorithm, achieved via implementations described herein, will hereby be known as Block Uniform Spatial Interpolation with Local Grid Optimization. The Block Uniform Spatial Interpolation with Local Grid Optimization estimates or interpolates a desired data value as a weighted summation of data values within a proximity or a vicinity of data previously acquired.

FIG. 3 is a flowchart which illustrates a method 300 for interpolating data values at interpolation locations from previously acquired data values. The method 300 interpolates data values using Block Uniform Spatial interpolation with Local Grid Optimization in accordance with one or more implementations described herein. Method 300 may be executed by a data processing system as described with regards to FIG. 10 below.

Method 300 may begin at step 305 after data (e.g., seismic data) has been acquired (e.g., from a land or marine based seismic data acquisition system). Next, at step 310 the data processing system may define a global grid. Similar to method 200, the global grid may contain nodes which correspond to locations where data values are desired. The global grid may be any type of grid corresponding to the desired interpolation locations, such as a Cartesian grid, a rectilinear grid, and the like. For example, the data processing system may define a global grid similar to the grid formed by the large diamonds illustrated in FIG. 1. Also, the grid may be defined such that all of the irregularly spaced data resides within the global grid.

At step 315, the data processing system may determine or select the locations where data values (e.g., seismic data values) may need to be estimated or interpolated. These locations may be the nodes on the global grid where actual data values were not acquired. The selected interpolation locations may make up a vector \vec{y}ⱼ(j=1, . . . , N) in a space of dimension N_{g} for estimation of data \hat{d}(\vec{y}ⱼ) from data \hat{d}(\vec{x}ⱼ) at the actual sampling locations \vec{x}ⱼ, j=1, . . . , M, \vec{x}ⱼ ε [symbol] ^{N}^{_{g}}.

At step 320, the data processing system may enter a loop containing a plurality of steps. The loop may be executed for each interpolation location in the vector \vec{y}ⱼ for which a data value needs to be interpolated (i.e., each interpolation location in the vector \vec{y}ⱼ(j=1, . . . , N)).

During the first step of the loop, step 325, for a selected interpolation location (e.g., \vec{y}₁) the data processing system may select a number of actual sampling locations in a proximity of or in the neighborhood or vicinity of the interpolation location \vec{y}₁. For example, the data processing system may select Mⱼ=Mⱼ(\vec{y}₁) actual sampling locations \vec{x}ᵢ=\vec{x}ⱼ, j=1, . . . , Mⱼ, \vec{x}ᵢε [symbol] ^{N}^{_{g}} in the vicinity or neighborhood of \vec{y}₁.

Then, at step 330 an acceptable mean square error (MSE_{ACC}) may be selected for an interpolation operator which will be calculated later in step 350. The acceptable mean square error may be a user specified threshold which may be used later for comparison with a mean square error for a calculated interpolation operator. An optimum interpolation operator may be determined by calculating interpolation operators for an output location until an interpolation operator is calculated which has a mean square error less than the user specified acceptable mean square error.

After selecting the MSE_{ACC}, a local grid may be selected or created. The local grid may be formed based on the actual sampling locations which are in the vicinity of the interpolation location, and the local grid may be selected such that the interpolation location is at the origin of the local grid. The local grid may be any suitable grid, such as, a Cartesian grid, a rectilinear grid, and the like. Selecting a local grid may result in a maximum possible spatial bandwidth. The cell size vector Δ\vec{c}=(Δc₁, . . . , Δc_{N}_{_{g}})^{T} may describe the local grid. The local grid cell size may be smaller or larger than a global grid cell size, and the local grid cell size may vary from interpolation location to interpolation location.

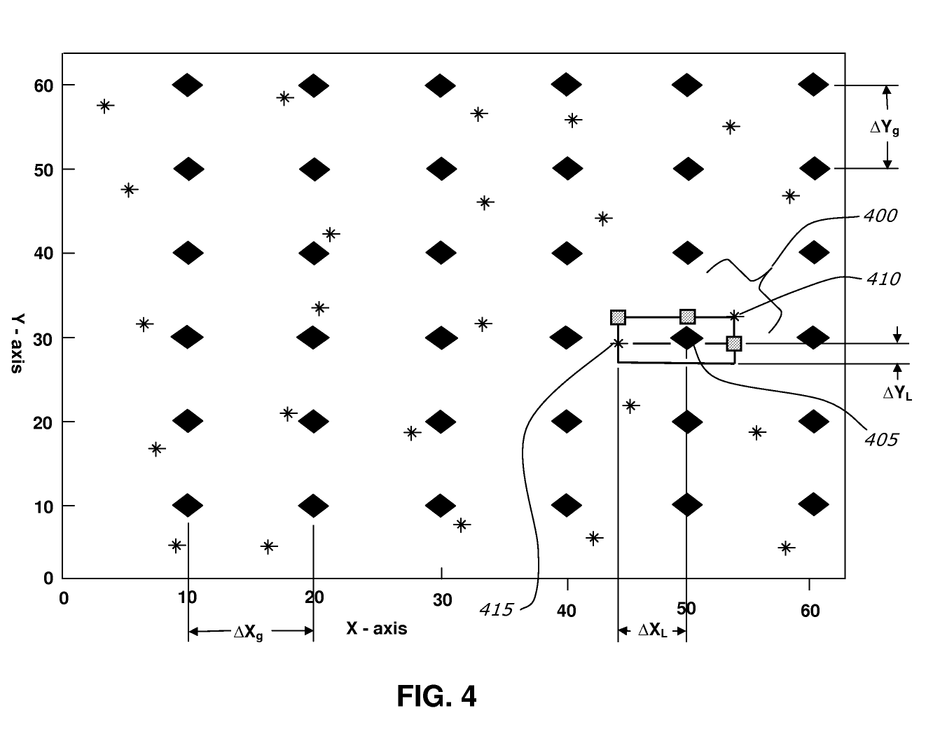

FIG. 4 illustrates an exemplary local grid 400. The diamonds illustrated in FIG. 4 are a portion of a larger global grid and the diamonds correspond to locations where data values are desired. The small stars illustrated in FIG. 4 correspond to locations where actual data (e.g., seismic data) was acquired. The local grid 400 illustrated in FIG. 4 has been selected or created for an interpolation location 405 within the global Cartesian grid. As illustrated, the local grid 400 has been created such that the desired interpolation location 405 is at the origin of the local grid 400. Furthermore, some of the nodes of the local grid 400 (e.g., node 410 and node 415) correspond to locations where actual seismic data has been sampled/acquired. The local grid 400 may contain cells which are of a different size than the global grid. For instance, the local grid 400 may contain cells which are smaller horizontally (i.e., Δx_{L}<Δx_{G}) and smaller vertically than the global grid (i.e., Δy_{L}<Δy_{G}).

Returning to method 300. After selecting a local grid, the data processing system may proceed to step 340 where a Mⱼ×Nⱼ matrix Ā=Ā(Δ\vec{c}) of interpolation coefficients may be formed for the local grid. The matrix Ā=Ā(Δ\vec{c}) may be formed based on the separable sinc function (e.g., Equation 4 described further below).

At step 345, the data processing system may compute the least squares inverse of the interpolation coefficients matrix (i.e., Ā⁻¹). Then, at step 350 a linear interpolation operator (i.e., \vec{w}) may be formed by extracting a row corresponding to the interpolation location from the least squares inverse matrix (i.e., Ā⁻¹). After forming the linear interpolation operator (\vec{w}), at step 355 a mean square error for the linear interpolation operator may be computed/calculated. A mathematical equation for calculating the mean square error for the interpolation operator is detailed below in Equation 2.

At step 360, the mean square error for the linear interpolation operator may be compared to the acceptable mean square error previously selected in step 330. At step 365, a determination is made as to whether the mean square error for the linear interpolation operator is greater than the acceptable mean square error.

If the mean square error for the linear interpolation operator is larger than or greater than the acceptable mean square error, the data processing system may proceed to step 370 where the data processing system may increase the local grid cell size. This increase in cell size may effectively decrease the spatial bandwidth for the interpolation operator for the interpolation location selected in step 320. After increasing the cell size of the local grid, the data processing system may proceed to step 340 to form a matrix of interpolation coefficients based on the separable sinc function. In addition to executing step 340, the data processing system may also execute steps 345, 350, 355, 360, and step 365 based on the increased cell size until the data processing system determines if a mean square error for a linear interpolation operator corresponding to the increased cell size of the local grid is less than or equal to the acceptable mean square error.

The data processing system may continue to return to step 370 and increase the cell size for the local grid until the cell size is large enough such that a mean square error for the corresponding linear interpolation operator is less than or equal to the acceptable mean square error. In this manner, an optimum linear interpolation operator may be selected for the interpolation location. The linear interpolation operator is optimum in the sense that it is calculated with the largest or maximum spatial bandwidth while having an acceptable mean square error as specified by the user in step 330.

However, if at step 365 a determination is made that the mean square error for the linear interpolation operator is less than or equal to the acceptable mean square error, the data processing system may proceed to step 375 where the mean square error for the linear interpolation operator may be saved. The data processing system may save the mean square error for the linear interpolation operator as a quality control measure for the interpolated data. The quality control measure may be displayed as a color coded attribute on a map of the interpolation locations. This color coded map would allow identification of regions in which the interpolation is relatively poor, as well as regions in which the interpolation is relatively good.

After saving the mean square error for the linear interpolation operator, at step 380 the data processing system may estimate/interpolate data value(s) at the selected interpolation location (\vec{y}ⱼ). The data processing system may estimate/interpolate the data value(s) at the selected interpolation location using a weighted summation of the sampling locations selected in step 325. That is, the data processing system may estimate/interpolate data values by multiplying the linear interpolation operator with the data at the actual sampling locations selected in step 325 and summing the products of the multiplication. The weighted summation may be represented by the equation:

$$d ( {\vec{y}}_{j} ) = {\sum }_{i = 1}^{{M}_{j}} {w}_{opt , i} d ( {\vec{x}}_{i} ) . \qquad Equation 1$$

Furthermore, in step 380 the data processing system may combine the computed linear interpolation operator with a spatial high-cut filter based on the cell size of the local grid. In addition to providing consistency, this extra filtering step may reduce artifacts in the interpolation data.

After estimating or interpolating the data at the interpolation location, the data processing system may return to step 320 to calculate an optimum linear interpolation operator for another interpolation location on the global grid. Furthermore, after data values have been estimated for all interpolation locations on the global grid, the data processing system may proceed from step 320 to step 385 where the method 300 may end.

Furthermore, various implementations described herein may also introduce a quality control measure. The quality control measure may predict the performance of the linear interpolation operators as a function of wave number (dip). Signals with higher wave numbers (stronger dip) are more difficult to interpolate. Hence the quality control measure depends on wave number (or dip) to reflect this situation.

According to implementations described herein, the data processing system may store the interpolated data for later use, may present the interpolated data visually to a user (e.g., via a monitor, printout, etc), or the data processing system may use the interpolated data for further data processing.

### Block Minimum Mean Square Error Interpolation with Bandwidth Optimization

As described above with regards to method 200, spatial bandwidth may be incorporated into the design of the interpolation operator. In one implementation, spatial bandwidth may be incorporated into the design of the interpolation operator by varying the wave number when calculating the interpolation operator. The wave number may be varied to select an optimum wave number for each interpolation location resulting in a maximum spatial bandwidth and an optimum interpolation operator for each interpolation location.

FIG. 5 is a flowchart which illustrates a method 500 for interpolating data values (e.g., seismic data values) from actual data values (e.g., using a weighted average over actual data in the neighborhood of interpolation locations). Furthermore, method 500 calculates an optimal interpolation operator by maximizing spatial bandwidth and calculating interpolation operators until an interpolation operator having a mean square error within a user specified acceptable mean square error is calculated.

Method 500 may be executed by a data processing system as described with regards to FIG. 10. Method 500 may begin at step 505 after data (e.g., seismic data) has been acquired (e.g., from a land or marine based seismic data acquisition system). Next, at step 510 the data processing system may define a global grid.

Similar to method 200, the global grid may contain nodes which correspond to locations where data values are desired. The global grid may be any suitable grid, such as, Cartesian, rectilinear, and the like, and may be defined such that all of the acquired data locations reside within the global grid.

At step 515, the data processing system may determine or select the locations where data values may need to be estimated/interpolated. These locations may be the nodes on the global grid where actual seismic data was not acquired. The selected interpolation locations may make up a vector \vec{y}ⱼ(j=1, . . . , N) in a space of dimension N_{g} for estimation of data \hat{d}(\vec{y}ⱼ) from data \hat{d}(\vec{x}ⱼ) at the actual sampling locations \vec{x}ⱼ, j=1, . . . , M, \vec{x}ⱼε [symbol] ^{N}^{_{g}}.

At step 520, the data processing system may enter a loop containing of a plurality of steps. The loop may be executed for each interpolation location \vec{y}ⱼ for which a data value needs to be interpolated, i.e., each interpolation location in the vector \vec{y}ⱼ(j=1, . . . , N).

During the first step of the loop, step 525, the data processing system may select a number of actual sampling locations in a proximity or in the neighborhood or vicinity of an interpolation location \vec{y}ⱼ. The data processing system may select Mⱼ=Mⱼ(\vec{y}ⱼ) actual sampling locations \vec{x}ᵢ=\vec{x}ⱼ,i=1, . . . , M, \vec{x}ᵢε [symbol] ^{N}^{_{g}} in the vicinity or neighborhood of \vec{y}ⱼ.

Then, at step 530 an acceptable mean square error (MSE_{ACC}) may be selected for an interpolation operator. The interpolation operator will be calculated later in step 550 of method 500. The acceptable mean square error may, for example, be a user specified threshold which may be used later for comparison with a mean square error for the calculated interpolation operator.

After selecting a MSE_{ACC}, at step 535 a maximum bandwidth may be selected. The maximum bandwidth may be selected by selecting a maximum wave number vector \vec{k}=\vec{k}ₘₐₓin [symbol] ^{N}^{_{g}}. The maximum wave number vector may be selected based on the nominal grid size, ki=1/(2*dxi), for each component of the wave number vector. Next, at step 540 a Mⱼ×Mⱼ(Mⱼ by Mⱼ) sized matrix S=S(\vec{k}) may be formed based on the separable sinc function of the differences of actual sampling locations, e.g., see Equation 3 and Equation 4 below. Then, at step 545 an Mⱼ sized vector \vec{r}=\vec{r}(\vec{k}) may be formed based on separable sinc functions of the differences of actual sampling locations and the selected interpolation location, e.g., see Equation 5 and Equation 6 below.

Next, at step 550 a Mⱼ sized linear interpolation operator vector \vec{w}=\vec{w}(\vec{k}) may be formed by applying the inverse of the matrix S to the vector \vec{r} (i.e., \vec{w}=\vec{w}(\vec{k})=S⁻¹\vec{r}). Then, a mean square error (MSE) for the linear interpolation operator vector (\vec{w}) may be calculated in step 555.

After calculating the MSE for the interpolation operator vector, at step 560 the data processing system may compare the acceptable mean square error selected in step 530 with the mean square error for the interpolation operator calculated in step 555. Then at step 565, the data processing system may determine if the mean square error for the interpolation operator is greater than the acceptable mean square error.

If during step 565 the data processing system determines that the mean square error for the interpolation operator is greater than the acceptable mean square error, the data processing system may proceed to step 570 to reduce the spatial bandwidth. The data processing system may reduce bandwidth by reducing the value of the wave number. Then the data processing system may repeat steps 540-560 to determine a new or a second interpolation operator using the reduced bandwidth and may determine a mean square error for the new interpolation operator. The data processing system may then compare the new mean square error for the new interpolation operator with the acceptable mean square error during step 565. If the new mean square error is not less than or equal to the acceptable mean square error, the data processing system may return to step 570 to again reduce the spatial bandwidth.

If the mean square error for the interpolation operator is less than or equal to the acceptable mean square error, the data processing system may proceed to step 575 of method 500 to save the interpolation operator mean square error as a quality control measure for interpolated data. Then at step 580, the data processing system may estimate or interpolate the data value at the interpolation location by applying the linear interpolation operator (\vec{w}) to the data at the selected actual sampling locations in the neighborhood or vicinity of the interpolation location.

After estimating the data value at the interpolation location, the data processing system may return to step 520 to select another interpolation location and repeat the processing loop beginning with step 525 for the selected interpolation location. After the data processing system has estimated a data value for all of the interpolation locations, the data processing system may proceed from step 520 to step 585 where method 500 may end.

Consequently, the data processing system may continue to reduce the spatial bandwidth (by reducing the wave number in step 570) until an interpolation operator is computed with the reduced bandwidth having a mean square error less than or equal to the acceptable mean square error. The data processing system may determine an optimal interpolation operator having a maximum spatial bandwidth (i.e., maximum wave number) and having an acceptable mean square error for each interpolation location.

According to implementations described herein, the data processing system may store the interpolated data for later use, may present the interpolated data visually to a user (e.g., via a monitor, printout, etc), or the data processing system may use the interpolated data for further data processing.

### Exemplary Estimation of Data as a Weighted Average

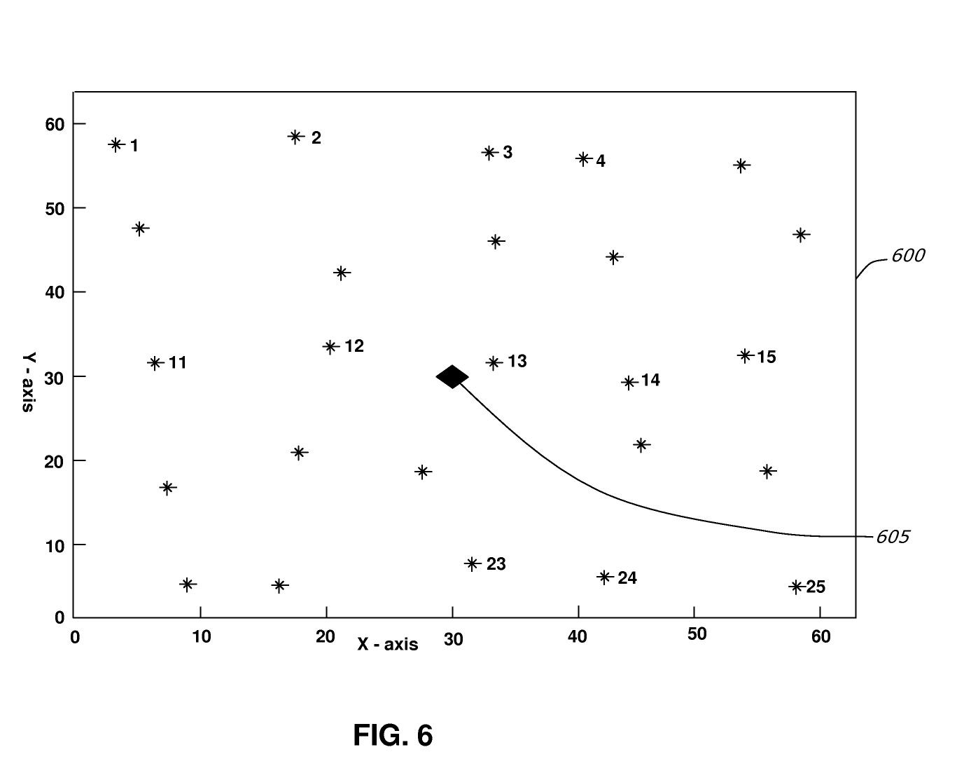

FIG. 6 illustrates exemplary data (e.g., seismic data) acquired at irregular sampling locations within an area 600. FIG. 6 also illustrates a location where data is desired. The actual sampling locations are indicated as stars, and the desired interpolation location 605 is indicated by the diamond. Twenty-five actual sampling locations are illustrated in FIG. 6, with the first sampling location occurring in the upper left hand corner and the twenty-fifth sampling location occurring in the lower right hand corner. An ordering number is illustrated in FIG. 6 alongside some of the actual sampling locations (e.g., 1, 2, 3, 4, etc.). Any ordering of the actual sampling locations would be acceptable for purposes of the implementation.

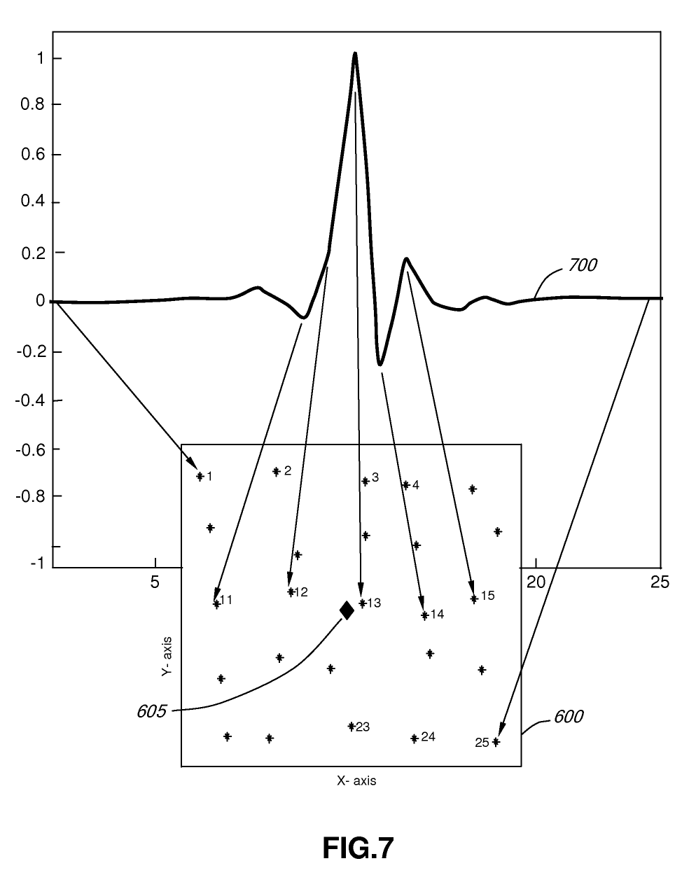

According to certain aspects of the implementation, an acceptable mean square error may be selected and spatial bandwidth optimization may be applied (e.g., maximum wave number or local grid) to calculate an optimal interpolation operator. FIG. 7 illustrates a calculated interpolation operator 700. The interpolation operator 700 is illustrated as the jagged horizontal line in FIG. 7. Various portions of the interpolation operator 700 correspond to actual sampling locations in the area 600. FIG. 7 illustrates this relationship via arrows from portions of the interpolation operator 700 to corresponding actual sampling locations (e.g., 1, 11-15, and 25). As illustrated, the interpolation operator 700 gives a larger weight to sampling locations close to the interpolation location 605 (e.g., sampling locations 11-15) and a smaller weight to sampling locations far away from the interpolation location 605 (e.g., sampling locations 1 and 25).

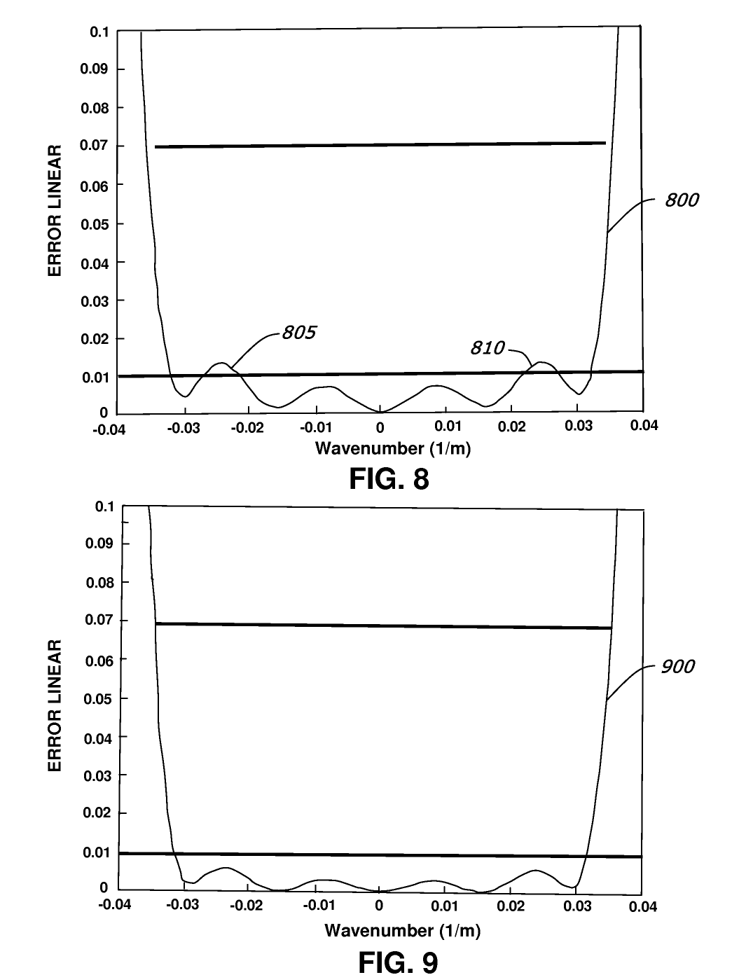

FIG. 8 illustrates an error spectrum corresponding to the interpolation operator 700 calculated with a spatial wave number k=0.04 1/m. FIG. 8 illustrates a diagonal 800 through a 2-dimensional wave number mean square interpolation error spectrum of the selected interpolation operator. The mean square error for the interpolation operator is just outside the acceptable level of 0.01 as illustrated by the two humps (e.g., hump 805 and hump 810) which exceed 0.01 at approximately wave number value −0.025 1/m and again at approximately wave number value 0.025 1/m.

In contrast, a slightly smaller bandwidth or spatial wave number of k=0.036 1/m may be used to create an interpolation operator with a corresponding diagonal through the error spectrum 900 as illustrated in FIG. 9. The diagonal through the error spectrum 900 displayed in FIG. 9 illustrates a mean square error now below the acceptable level of 0.01. The minimal improvement in bandwidth achieved using a larger wave number (0.04 1/m as opposed to 0.036 1/m), is indicated by the width of the horizontal line at error level 0.07. Although the interpolation operator may have a larger bandwidth, the tradeoff is a larger mean square error in the interpolation band.

### Interpolation Operator Calculation and Minimum Mean Square Error Calculation

The minimum mean square error (MMSE) interpolation operator can be computed from the following matrix/vector equation:

\vec{w}(\vec{k})=S⁻¹(\vec{k})\vec{r}(\vec{k}) Equation 2.

In Equation 2, S is the sampling location matrix which depends only on the differences between actual sampling locations. Furthermore, \vec{r} is a vector which depends on the actual sampling locations and the interpolation location. Both S and \vec{r} also depend on the spatial bandwidth, represented by a wave number vector which may need to be selected in an optimum way. A mathematical derivation of Equation 2 is presented below.

The sampling location matrix S depends on the differences of the actual location vectors via a product of individual component sinc functions and the spatial bandwidth as shown in the following equations:

$$\begin{matrix}S = S ( \vec{k} ) = ( {s}_{i , j} , 1 \leq i , j \leq M ) & Equation 3 \\ {s}_{i , j} = {\prod }_{m = 1}^{{N}_{g}} \frac{sin ( 2 π {k}_{m} ( {x}_{i , m} - {x}_{j , m} ) )}{2 π {k}_{m} ( {x}_{i , m} - {x}_{j , m} )} . & Equation 4\end{matrix}$$

The size M of the sampling location matrix depends on the number of samples (e.g., seismic traces) actually selected to compute the interpolated data, and may vary for different interpolation locations as outlined above. The vector \vec{k}=(k₁, . . . ,k_{N}_{_{g}})^{T} denotes the wave number vector, with physical dimension given the inverse to the dimensions used for distances between sampling locations, usually 1/m or 1/km. This vector may be selected in an optimum way, as outlined below.

The vector \vec{r} depends on the difference vector between the actual sampling locations and the interpolation location, as well as on the spatial bandwidth, and is defined as the following product of individual component sinc functions:

$$\begin{matrix}\vec{r} = {( {r}_{1} , … , {r}_{M} )}^{T} & Equation 5 \\ {r}_{i} = {\prod }_{m = 1}^{{N}_{g}} \frac{sin ( 2 π {k}_{m} ( {x}_{i , m} - {x}_{j , m} ) )}{2 π {k}_{m} ( {x}_{i , m} - {y}_{j , m} )} . & Equation 6\end{matrix}$$

The size of the vector may correspond to the size of the sampling locations matrix, i.e., the number of samples selected to compute the interpolation data, and may vary with the interpolation locations. The elements of this vector are sometimes already used as the weights of the interpolation operator. However, this may not be optimum; such an operator is “off” by the sampling location matrix, which has to be taken “away”, as shown in Equation 2.

The mean square error of any candidate interpolation operator, relative to base cosine functions of amplitude \sqrt{2}^{N}^{_{g}}, and averaged over wave number and phase, is expressed as:

$$MSE = 1 - 2 {\sum }_{i = 1}^{M} {w}_{i} {r}_{i} + {\sum }_{i , j}^{M} {w}_{i} {w}_{j} {s}_{i , j} ; \qquad Equation 7$$

while the minimum mean square error is expressed as

$$MMSE = 1 - {\sum }_{i = 1}^{M} {w}_{i} {r}_{i} ; \qquad Equation 8$$

if the weights are computed according to Equation 2.

### Mathematical Derivations of Formula used Above

This section provides the mathematical derivations of some of the formulae used above. Consider base functions

b(x)=\sqrt{2} cos(2πkx+φ) Equation 9;

with the wave number k measured in 1/m and phase 0≦φ≦2π. The base functions are normalized to have maximum amplitude \sqrt{2}, which ensures that the root mean square value of the base function, averaged over phase, is unity at each wave number. The interpolation error may be defined as:

ε=Σwᵢb(xᵢ)−b(y) Equation 10

for the problem of interpolating the base function at sampling location y from actual sampling locations xᵢ. Substituting Equation 8 in Equation 9 yields:

$$ɛ ( k , ϕ ) = \sqrt{2} [ {\sum }_{i} ( \begin{matrix}{w}_{i} cos ( 2 π kx + ϕ ) - \\ cos ( 2 π ky + ϕ )\end{matrix} ] . \qquad Equation 11$$

The phase mean square error may be defined via:

$$\begin{matrix}{E}^{2} ( k ) = \frac{1}{2 π} {\int }_{0}^{2 π} d {ϕɛ}^{2} ( k , ϕ ) . \\ Since \text{:} & Equation 12 \\ \int d ϕ cos ( a + ϕ ) cos ( b + ϕ ) = π cos ( a - b ) & Equation 13\end{matrix}$$

the integral defining the phase mean square error can be evaluated analytically via

$$\begin{matrix}{E}^{2} ( k ) = 1 - 2 {\sum }_{i} {w}_{i} cos ( 2 π k ( {x}_{i} - y ) ) + \\ {\sum }_{i , j} {w}_{i} {w}_{j} cos ( 2 π k ( {x}_{i} - {x}_{j} ) ) .\end{matrix} \qquad Equation 14$$

Given the operator coefficients, Equation 12 allows computation of the phase mean square interpolation error for each wave number.

Similarly, the phase and wave number mean square error may be defined using the following equation:

$${\overline{E}}^{2} = \frac{1}{{k}_{max}} {\int }_{0}^{{k}_{max}} d {kE}^{2} ( k ) . \qquad Equation 15$$

Equation 15 may be computed analytically using the following equation:

$$\begin{matrix}{\overline{E}}^{2} = 1 - 2 {\sum }_{i} {w}_{i} s ( 2 π {k}_{max} ( {x}_{i} - y ) ) + \\ {\sum }_{i , j} {w}_{i} {w}_{j} s ( 2 π {k}_{max} ( {x}_{i} - {x}_{j} ) )\end{matrix} \\ where s ( x ) = \frac{sin ( x )}{x} . \qquad Equation 16$$

In this manner, Equation 7 is proven for the 1-dimensional case.

Differentiating Equation 14 with respect to wⱼ gives the following equation:

$$\frac{\partial {\overline{E}}^{2}}{\partial {w}_{j}} = 2 ( {\sum }_{i} {w}_{i} s ( 2 π k ( {x}_{i} - {x}_{j} ) ) - s ( 2 π k ( {x}_{i} - y ) ) ) . \qquad Equation 17$$

Furthermore, setting Equation 17 to zero

$$( i . e . , \frac{\partial {\overline{E}}^{2}}{\partial {w}_{j}} = 0 ) ,$$

yields a simple linear system represented by the following equations:

$$S \vec{w} = \vec{r} , {s}_{i , j} = \frac{sin ( 2 π k ( {x}_{i} - {x}_{j} ) )}{2 π k ( {x}_{i} - {x}_{j} )} , \\ and {r}_{i} = \frac{sin ( 2 π k ( {x}_{i} - y )}{2 π k ( {x}_{i} - y )} . \qquad Equation 18$$

The linear system represented by Equation 18 can be solved for the operator weights \vec{w}=S⁻¹\vec{r}, which proves Equation 2 for the 1-dimensional case.

Consequently, Equation 7 may be proofed for the 1-dimensional case by re-writing Equation 14 as Ē²=1−2\vec{w}^{T}\vec{r}+\vec{w}^{T}S\vec{w} and using S\vec{w}=\vec{r} from Equation 18.

Therefore, the general n-dimensional case may be solved by replacing the 1-dimensional sinc function by the product sinc functions

$$s ( \vec{x} ) = {\prod }_{i = 1}^{dim ( \vec{x} )} \frac{sin ( 2 π {k}_{i} {x}_{i} )}{2 π {k}_{i} {x}_{i}}$$

in Equation 16 and Equation 17. Correspondingly, the cosine function in Equation 12 may be replaced by the product cosine function.

### Exemplary Computing System

FIG. 10 illustrates a computing system 1000, into which implementations of various techniques described herein may be implemented. The computing system 1000 (data processing system) may include one or more system computers 1030, which may be implemented as any conventional personal computer or server. However, those skilled in the art will appreciate that implementations of various techniques described herein may be practiced in other computer system configurations, including hypertext transfer protocol (HTTP) servers, hand-held devices, multiprocessor systems, microprocessor-based or programmable consumer electronics, network PCs, minicomputers, mainframe computers, and the like.

The system computer 1030 may be in communication with disk storage devices 1029, 1031, and 1033, which may be external hard disk storage devices. It is contemplated that disk storage devices 1029, 1031, and 1033 are conventional hard disk drives, and as such, will be implemented by way of a local area network or by remote access. Of course, while disk storage devices 1029, 1031, and 1033 are illustrated as separate devices, a single disk storage device may be used to store any and all of the program instructions, measurement data, and results as desired.

In one implementation, seismic data from the receivers may be stored in disk storage device 1031. The system computer 1030 may retrieve the appropriate data from the disk storage device 1031 to process seismic data according to program instructions that correspond to implementations of various techniques described herein. The program instructions may be written in a computer programming language, such as C++, Java and the like. The program instructions may be stored in a computer-readable medium, such as program disk storage device 1033. Such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the system computer 1030. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of any of the above may also be included within the scope of computer readable media.

In one implementation, the system computer 1030 may present output primarily onto graphics display 1027, or alternatively via printer 1028. The system computer 1030 may store the results of the methods described above on disk storage 1029, for later use and further analysis. The keyboard 1026 and the pointing device (e.g., a mouse, trackball, or the like) 1025 may be provided with the system computer 1030 to enable interactive operation.

The system computer 1030 may be located at a data center remote from the survey region. The system computer 1030 may be in communication with the receivers (either directly or via a recording unit, not shown), to receive signals indicative of the reflected seismic energy. These signals, after conventional formatting and other initial processing, may be stored by the system computer 1030 as digital data in the disk storage 1031 for subsequent retrieval and processing in the manner described above. While FIG. 10 illustrates the disk storage 1031 as directly connected to the system computer 1030, it is also contemplated that the disk storage device 1031 may be accessible through a local area network or by remote access. Furthermore, while disk storage devices 1029, 1031 are illustrated as separate devices for storing input seismic data and analysis results, the disk storage devices 1029, 1031 may be implemented within a single disk drive (either together with or separately from program disk storage device 1033), or in any other conventional manner as will be fully understood by one of skill in the art having reference to this specification.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for interpolating seismic data, comprising:
(a) receiving seismic data acquired at irregularly spaced sensor locations;
(b) defining a global grid having nodes corresponding to locations where seismic data values are desired;
(c) selecting an output location corresponding to a node on the global grid;
(d) setting a maximum bandwidth for an interpolation operator; and
(e) computing the interpolation operator for the selected output location based on the maximum bandwidth.

2. The method of claim 1, further comprising:
(f) computing a mean square error for the interpolation operator; and
(g) determining if the mean square error for the interpolation operator is acceptable.

3. The method of claim 2, further comprising:
if the mean square error is acceptable, calculating an interpolated seismic data value for the selected output location using the interpolation operator and the acquired seismic data.

4. The method of claim 2, further comprising:
if the mean square error is unacceptable:
reducing the maximum bandwidth;
computing a second interpolation operator for the selected output location based on the reduced maximum bandwidth;
computing a mean square error for the second interpolation operator; and
determining if the mean square error for the second interpolation operator is acceptable.

5. The method of claim 1, wherein steps (c)-(e) are repeated for each location on the global grid.

6. The method of claim 1, wherein the global grid is an n-dimensional grid wherein n is an integer greater than zero.

7. The method of claim 1, wherein the global grid is defined such that the sensor locations reside within boundaries of the global grid

8. A method for interpolating seismic data, comprising:
(a) receiving seismic data acquired at irregularly spaced sensor locations;
(b) defining a global grid having nodes corresponding to locations where seismic data values are desired;
(c) selecting actual sensor locations within a vicinity of a desired interpolation location residing on the global grid;
(d) selecting an acceptable mean square error for an interpolation operator;
(e) selecting a local grid for the interpolation location; and
(f) forming a matrix of interpolation coefficients for the local grid.

9. The method of claim 8, wherein the method further comprises:
(g) computing a least squares inverse of the matrix of interpolation coefficients;
(h) forming an interpolation operator by extracting a row corresponding to the interpolation location from the least squares inverse of the matrix of interpolation coefficients;
(i) computing a mean square error for the interpolation operator;
(j) comparing the mean square error for the interpolation operator with the acceptable mean square error; and
(k) if the means square error for the interpolation operator is less than or equal to the acceptable mean square error, calculating a seismic data value at the interpolation location by applying the linear interpolation operator to seismic data acquired at actual sensor locations.

10. The method of claim 9, further comprising:
if the mean square error for the interpolation operator is greater than the acceptable mean square error, increasing a cell size of the local grid;
forming a second matrix of interpolation coefficients for the local grid with an increased cell size;
computing a least squares inverse of the second matrix of interpolation coefficients;
forming a second interpolation operator by extracting a row corresponding to the interpolation location from the least squares inverse of the second matrix of interpolation coefficients;
computing a mean square error for the second interpolation operator;
comparing the mean square error for the second interpolation operator with the acceptable mean square error; and
calculating a seismic data value at the interpolation location by applying the second linear interpolation operator to seismic data acquired at actual sensor locations.

11. The method of claim 9, further comprising, saving the mean square error for the interpolation operator as a quality control measure for interpolated data.

12. The method of claim 9, wherein the local grid comprises at least one grid point not on the global grid.

13. The method of claim 9, wherein forming a matrix of interpolation coefficients is performed using a separable sinc function.

14. The method of claim 9, wherein the local grid is selected such that the interpolation location is located at an origin of the local grid.

15. The method of claim 9, wherein a cell size of the local grid is smaller than a cell size of the global grid.

16. A method of interpolating seismic data, comprising:
(a) receiving seismic data acquired at actual sensor locations;
(b) defining a global grid having nodes corresponding to locations where data values are desired;
(c) selecting actual sensor locations within a vicinity of an interpolation location residing on the global grid;
(d) selecting an acceptable mean square error for an interpolation operator;
(e) selecting a maximum bandwidth for the interpolation operator;
(f) forming a matrix of interpolation coefficients based on the separable sinc function of the differences of actual sampling locations;
(g) forming a vector based on separable sinc functions of the difference of selected actual sampling locations and the selected interpolation location; and
(h) forming an interpolation operator vector by application of the inverse of the matrix of interpolation coefficients to the vector.

17. The method of claim 16, further comprising:
(i) computing a mean square error for the interpolation operator vector;
(j) comparing the mean square error for the interpolation operator vector with the acceptable mean square error; and
(k) if the mean square error for the interpolation operator vector is less than or equal to the acceptable mean square error, estimating a seismic data value for the interpolation location using the interpolation operator vector.

18. The method of claim 16, further comprising:
if the mean square error for the interpolation operator vector is greater than the acceptable mean square error, reducing the bandwidth for the interpolation operator;
forming a matrix of interpolation coefficients based on the separable sinc function of the differences of actual sampling locations;
forming a vector based on separable sinc functions of the difference of selected actual sampling locations and the selected interpolation location; and
forming a second linear interpolation operator vector by application of the inverse of the matrix of interpolation coefficients to the vector.

19. The method of claim 17, further comprising: saving the mean square error for the interpolation operator vector as a quality control measure for interpolated data.

20. A computer-readable medium having stored thereon computer-executable instructions which, when executed by a computer, cause the computer to perform operations comprising:
(a) receiving seismic data acquired at irregularly spaced sensor locations;
(b) defining a global grid having nodes corresponding to locations where seismic data values are desired;
(c) selecting an output location corresponding to a node on the global grid;
(d) setting a maximum bandwidth for an interpolation operator;
(e) computing the interpolation operator for the selected output location based on the maximum bandwidth;
(f) computing a mean square error for the interpolation operator;
(g) determining if the mean square error for the interpolation operator is acceptable; and
(h) if the mean square error is acceptable, calculating an interpolated seismic data value for the selected output location using the interpolation operator and the acquired seismic data.

21. The computer readable medium of claim 20, wherein the operations further comprise:
if the mean square error is unacceptable:
reducing the maximum bandwidth;
computing a second interpolation operator for the selected output location based on the reduced maximum bandwidth;
computing a mean square error for the second interpolation operator; and
determining if the mean square error for the second interpolation operator is acceptable.

22. A computer system, comprising:
a processor; and
a memory comprising program instructions executable by the processor to:
(a) receive seismic data acquired at irregularly spaced sensor locations;
(b) define a global grid having nodes corresponding to locations where seismic data values are desired;
(c) select an output location corresponding to a node on the global grid;
(d) set a maximum bandwidth for an interpolation operator;
(e) compute the interpolation operator for the selected output location based on the maximum bandwidth;
(f) compute a mean square error for the interpolation operator; and
(g) determine if the mean square error for the interpolation operator is acceptable.

23. The computer system of claim 22, wherein if the mean square error is acceptable, the memory further comprises program instructions executable by the processor to calculate an interpolated seismic data value for the selected output location using the interpolation operator and the acquired seismic data.

24. The computer system of claim 22, wherein if the mean square error is unacceptable the memory further comprises program instructions executable by the processor to:
reduce the maximum bandwidth;
compute a second interpolation operator for the selected output location based on the reduced maximum bandwidth;
compute a mean square error for the second interpolation operator; and
determine if the mean square error for the second interpolation operator is acceptable.
